(19) United States
(12) Patent Application Publication
(10) Pub. No.: US 2003/0212973 A1
(43) Pub. Date: Nov. 13, 2003

(54) Methods for full-chip vectorless dynamic IR analysis in IC designs

(76) Inventors: Shen Lin, Foster City, CA (US); Andrew Yang, Cupertino, CA (US); Norman Chang, Fremont, CA (US)

Correspondence Address: EMIL CHANG, LAW OFFICES OF EMIL CHANG, 674 JASMINE DRIVE, SUNNYDALE, CA, 94086, US

(21) Appl. No.: 10/437,644

(22) Filed: May 13, 2003

Related U.S. Application Data
(60) Provisional application No. 60/380,360, filed on May 13, 2002.

(51) Int. Cl. G06F 9/45; G06F 17/50

(52) U.S. Cl. 716/6

(57) ABSTRACT

Methods for efficient integrated circuit (“IC”) dynamic IR-drop analysis algorithm are disclosed. In one aspect, the disclosed methods eliminate the need for peak-power input stimulus vectors or Verilog's value change dump (“VCD”). Rather than performing transient simulation over a long set of input vectors to determine the worst dynamic IR, the disclosed method statistically determines the switching direction and the timing for each instance based on its block or module switching scenario. Full-chip transient simulation, including the RLC extracted from the power-ground network, is then performed accordingly over a few clock cycles. This approach makes feasible full-chip dynamic IR-drop verification with the consideration of power-ground inductance and capacitance. Furthermore, methods are disclosed for optimal decoupling-capacitor insertion for remedying power-integrity problems, including their amounts and locations.

### CROSS REFERENCE

This application claims priority to a provisional application entitled “Method for Full-Chip Vectorless Dynamic IR-drop Analysis in IC Designs” filed on May 13, 2002, having an application Ser. No. 60/380,360. This application further claims priority to a non-provisional application entitled “Method for Full-Chip Vectorless Dynamic IR and Timing Impact Analysis in IC Designs” filed on Mar. 28, 2003, having an Application No. yet to be assigned.

### FIELD OF INVENTION

The present invention generally relates to methods for circuit analysis of integrated circuit designs, and, in particular, dynamic IR analysis in integrated circuit designs.

### BACKGROUND

As the development of integrated circuits (IC) chip advances, a number of parameters for the chip changes as well. These parameters include (1) reduction in the supply voltage, (2) increase in operating frequency, and (3) reduction in feature size. Correspondingly, power supply fluctuation caused by IR-drop, Ldi/dt, or LC resonance can result in a significant impact to the timing and functionality of the IC. In general, a 10% fluctuation may translate to more than 10% timing uncertainty such that verification of the power supply integrity becomes a tape-out requirement in advance IC designs in order to ensure that the IC will function as designed.

If the chip's operating frequency is not high, static-IR drop verification may be adequate and its approach has been well studied and developed. The average supply current to each instance, including its loading current, short-circuit current, and leakage current, over several cycles is used to determine the full chip IR drop. Because the intrinsic decoupling capacitance existing in the chip between power and ground networks may provide enough current-spike filtering, the power and ground voltages stay within a small range around the values determined from the average current.

However, when operating frequency becomes higher or a group of nearby high-power cells switch simultaneously, the charge in the capacitors may be exhausted, causing severe power supply fluctuations. In this case, within-cycle transient analysis, including the consideration of power-ground RLC and intrinsic and inserted decoupling capacitors (i.e. decaps), is needed to determine the peak noise on the power-ground network. This analysis is defined as the dynamic-IR analysis.

The most difficult challenge in dynamic-IR analysis is in determining each cell's switching condition in the peak-drop situation. That includes the determinations of which cells will switch, how they will switch (0 → 1 or 1 → 0), and when they will switch within that cycle or a couple of cycles. The states of un-switched cells may affect the amount of intrinsic decoupling capacitors and hence, also need to be determined. In prior art methods, exhaustive transistor-level or gate-level simulation approach was used. The input stimulus for the simulation is given either by designers (often from RTL function verification vectors, likely not peak-power vectors) or from some intelligent random number generators, e.g. Genetic algorithm.

However, there are fundamental problems with the prior art simulation approaches. First, a prohibitively long set of input vectors is needed to explore every possible corner in a complicated design, especially in a state machine with many states. Furthermore, the worst case may depend on a sequence of inputs, which makes the approach even more infeasible. Second, the worst dynamic-IP drop is influenced by the design of the power-ground networks. It is difficult for a gate-level simulator to consider the electrical effects of the networks. However, performing electrical simulation on the long set of vectors is computationally impossible. Thirdly, these approaches lack the confidence measurement. Even after a very long simulation, designers still do not have any idea of how far away the peak current are from the true peak. Fourthly, in the designs adopting built-in-self-test (“BIST”) circuits, the peak current in the normal operation mode may be much less than the peak current in BIST mode. For example, all banks of memory may be turned on simultaneously in BIST mode. However, any die failing BIST has to be thrown away. Therefore, the peak current determined from simulation may be too optimistic.

The Automatic Test Pattern Generation (“ATPG”) approach was also proposed in generating the peak-power input and state vectors. This algorithm searches for the input and state vectors that will incur the largest number of 0 → 1 switchings in high power cells. However, the fundamental problems with the ATPG approach include, first, the reliance on the assumption that every vector is possible out of the registers, latches, or flip-flops. This means every state is reachable. Quite often the number of reachable state is small and hence the results are too pessimistic. Secondly, similar to the problem of the gate-level simulation approach, it is difficult to consider the design of power-ground networks and electrical effects. Thirdly, this approach ignores the timing-correlation between cells as it only considers the logic satisfiability. Due to timing delays, some cells may not switch simultaneously. Fourthly, similar to the problem with the gate-level simulation approach, its results may be optimistic if BIST is adopted. Lastly, in handling complicated designs, ATPG's run time may be too long because it is an NP-Complete problem in general as is known in the art.

Given the issues with respect to current methods in conducting dynamic-IR analysis, it is therefore desirable to have novel methods for dynamic IR analysis that can overcome the problems of the current state of the art.

### SUMMARY OF THE INVENTION

It is therefore an object of the present invention to provide vectorless, statistical methods for conducting dynamic IR analysis in IC designs.

It is another object of the present invention to provide vectorless, statistical methods for determining instance switching timing in conducting dynamic IR analysis in IC designs.

It is yet another object of the present invention to provide vectorless, statistical method for determining instances requiring decap protection.

Briefly, statistical, vectorless dynamic IR analysis methods for simulating integrated circuit design are presented. In one aspect of the invention, statistical methods for determining instance switching in simulating integrated circuit design is disclosed. In determining instance switching, the statistical methods may use several types of information including one or more random numbers, empirical switching data, user provided probability values, etc. These statistical methods can also be applied in determining switching timing. Instead of relying on input vectors, integrated circuit design simulation can be carried out using statistical information.

An advantage of the present invention is that it provides vectorless, statistical methods for conducting dynamic IR analysis in IC designs.

Another advantage of the present invention is that it provides vectorless, statistical methods for determining instance switching timing in conducting dynamic IR analysis in IC designs.

Yet another advantage of the present invention is that it provides vectorless, statistical method for determining instances requiring decap protection.

### IN THE DRAWINGS

FIG. 1 illustrates an example of an instance-switching-charge histogram;

FIGS. 2a and 2b illustrate the method steps of the presently preferred embodiment of the present invention;

FIGS. 3a and 3b illustrate examples of load current waveforms;

FIG. 4 illustrates the method steps for an alternative embodiment of the present invention, statistical vectorless dynamic IR analysis based on peak-to-average power scenario;

FIG. 5 illustrates the method steps of an aspect of the present invention in determining Target-Cells based on the worst Vdd-Gnd voltage; and

FIG. 6 illustrates the method steps of an aspect of the present invention in determining Target-Cells based on the dv/dt of the Vdd-Gnd voltage.

### DETAIL DESCRIPTION OF THE PREFERRED EMBODIMENT

The following defined terms are used in describing embodiments of the present invention. It shall be understood that these definitions facilitates the understanding of the present invention and shall not be used to limit the possible variations and scope of the present invention.

Instance-Switch-Charge Histogram. Cells of a chip design may be instantiated thousands of times during simulation, each time using different combinations of variables generating the instances. Methods for categorizing and selecting instances are therefore needed. Instance-Switch-Charge histogram is one categorizing method and can be constructed in a variety of manners to assist the user to visually identify and determine the cells to select for processing (the “Hot-Cells” as further described below). Generally speaking, the entire set of instances is comprised of special and non-special instances. Special instances are those instances with known switching patterns and timings, such as clock buffers which toggle twice in a cycle with pre-determined skews and scan buffers which may never toggle in normal operation modes. Non-special instances are comprised of two types, Hot-Cells and non-Hot-Cells, as defined below.

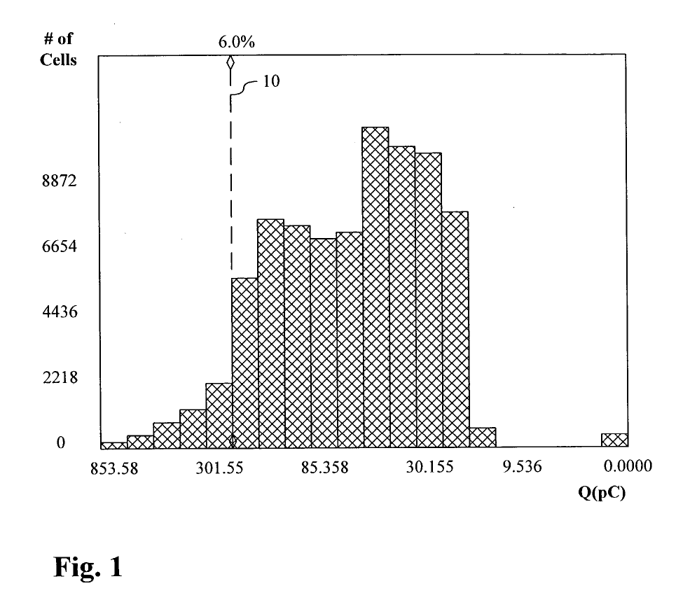

As an example, referring to FIG. 1, the histogram illustrated here is the total 0 → 1 switching charge, including loading charge, short-circuit charge, and the leakage charge during that 0 → 1 switching of all non-special instances of the chip. The x-axis of the histogram is the instance charge values ranging from the maximum to the minimum values found during the switching of the chip design, and the y-axis or the height of each bar is the number of instances found to be in that value range. To create a histogram, the instance based on their 0 → 1 energy is sorted in descending order. At a charge number C on the x-axis, referring to the dash-line at 10, the percentage of instances having charge more than C can be known by counting this sorted list. Generally speaking, instance switching from 0->1 provides a higher surge in power that may affect the performance of the chip design, while instance switching from 1->0 provides a lower power surge that has to a lesser extent affect on the performance of the chip design.

Hot-Cells. Hot-Cells are defined herein as those selected non-special instances which generally have higher instance-switching-charge values. Because of its higher instance-switching-charge value, Hot-Cells are more likely to contribute power supply fluctuations and therefore the stability of the chip design. Therefore, particular attention is paid to Hot-Cells. A useful definition is Hot-Cells of p % for selecting p % of the non-special instances for processing. Given the number p, by sliding the dash vertical line of the histogram of FIG. 1, there exist uniquely one charge number C giving p % of the instances at the left of the line. Hot-Cells of p % is the sum of those cells at the left of the dashed line indicated at 10. Hot-Cells contribute much more to the dynamic noise; so in the worst case, their switching probability probably needs to be higher. There are many ways to define Hot-Cells for processing. For example, Hot-Cells may be defined based on instance-switching-charge distribution, instance power distribution, and other statistical and non-statistical methods for selecting Hot-Cells based on instance charge, instance power, etc.

Red-Cells. Red-Cells are those Hot-Cells having its supply voltage dropping below a pre-defined voltage, Vr. More specifically, a Red-Cell of (p %, Vr) is an instance in Hot-Cells of p % with its supply voltage between one of its Vdd-Gnd pin pairs (may be just one pair) dropping below Vr. A Vdd-Gnd pin pair is the closest Vdd and Gnd pins. An instance has the number of Vdd-Gnd pin pairs equal to the larger of the number of its Gnd pins and the number of its Vdd pins. Red-Cells indicate those Hot-Cells that may need to have decoupling capacitor inserted nearby to prevent excessive voltage drop.

Target-Cells. A Target-Cell is a Red-Cell determined to need one or more decoupling capacitors inserted nearby. More specifically, a Target-Cell of (p %, Vr) is an instance in Red-Cells of (p %, Vr) that needs decoupling capacitor placed near-by for dynamic-IR protection.

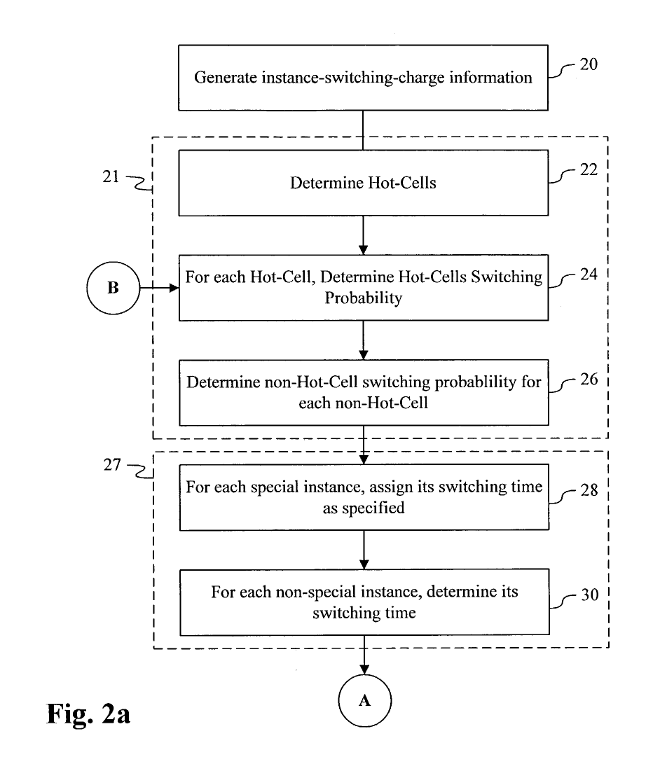

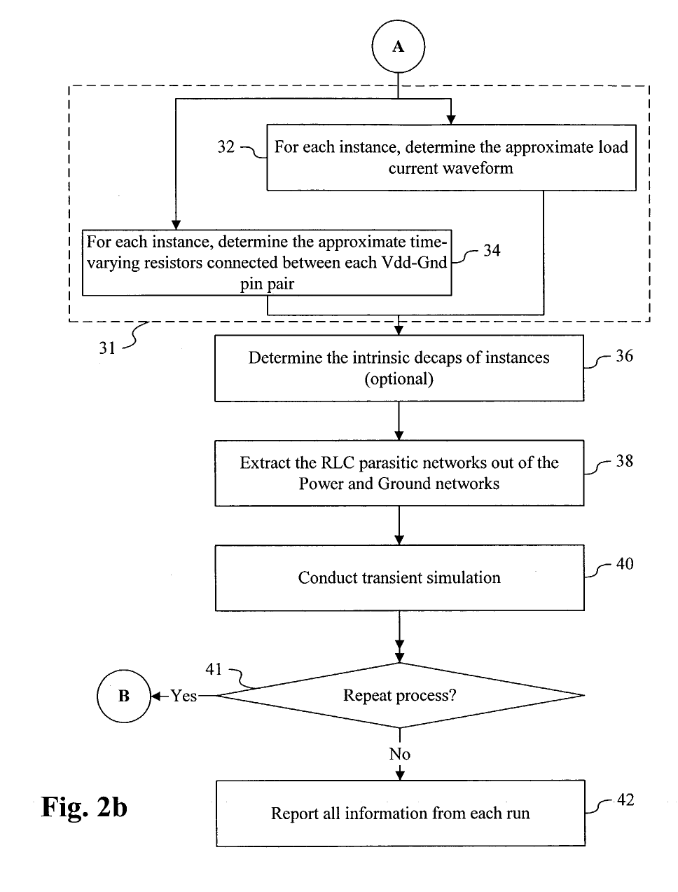

Switching Scenarios. Switch Scenarios is defined here as methods for constructing switching scenarios for the analysis of Hot-Cells. One example of a switching scenario definition is Switch Scenario of (p %, hcsp, tgp, slew) for a block or a module in the chip design. It specifies a switching scenario that Hot-Cells may switch from 0 to 1 with the probability hcsp (hot cell switching probability), and may switch from 1 to 0 (or stay at 1 or 0) with the probability, in one example, (1-hcsp)/3. The rest of non-special instances, the non-Hot-Cells, may switch with the probability tgp (toggle probability). This means both 0 → 1 switching and 1 → 0 switching with the probability tgp/2, and both staying at 1 and at 0 with the probability (1-tgp)/2. The typical slew rate for those switching cells is slew expressed in pico-second. FIG. 2a, at 21 and 27, is an illustration of the steps for implementing switching scenarios, including Switching Scenarios defined herein.

Peak-to-Average-Power Scenario. Peak-to-Average-Power Scenario is another method for constructing switching scenarios. More specifically, Peak-to-Average-Power Scenario of m specifies the switching scenario for a block or a module that its peak instantaneous power is m times its average over several cycles, where m is a real number greater than 1. The typical switching slew rate is slew in pico-second.

Clock domain of an Instance. Clock signals provide switching frequency and switching timing information. In circuit, signal paths start from primary inputs, flip-flops, or latches and end at primary outputs, flip-flops, or latches. Flip-flops and latches are controlled by clock signals, which may be also functions of other inputs and clocks in the designs adopting gated clocks. If those inputs are known, the clock frequency or clock domain to flip-flops and latches may be determined. If not, the fastest clock determines the clock domain. There is one special clock domain, denoted by System Domain, which is assigned to primary inputs. The frequency of System Domain is determined by the chip design's input rate. After the domains for primary inputs, flip-flops, and latches are determined, the domain tags may be propagated forward in a breadth-first fashion till other primary outputs, flip-flops, or latches are met. If multiple clock domain tags reach the same instance, the one with higher frequency is preserved.

I. Vectorless Dynamic IR-Drop Analysis in IC Designs based on Each Module's Statistical Switching Scenario

As discussed above, it is almost impossible to exhaustively simulate all input sequences to determine the peak power drop or ground bounce. Even if this peak is found, the chip design still may not be designed-constraint by it because that may lead to a very conservative and costly design, leaving too much performance untapped. In fact the IC design process has always been a process considering a lot of uncertainties and has always been focusing on a 3-sigma distribution, meaning the majority of the cases. It is acceptable to throw away bad dies on the tester as long as the overall yield is satisfactory.

Therefore, instead of deterministically looking for the hard-to-find peak, the present invention, in one aspect, presents methods using the statistical peak noise under certain switching scenarios for power-integrity verification and hot-spot identification. In one form, this is Red Cell and Target-Cell identification. Through several runs with user-specified scenario statistics, a collection of Red Cells and Target Cells may be identified. One of the key advantages here of the present invention is that the full-chip analysis may be efficiently performed. Also, either Switching Scenario or Peak-to-Average-Power Scenario can be easily specified by the designers to effectively simulate different chip operating conditions. For example, if a designer desires to simulate the situation that a floating point unit in a microprocessor is to turn ON after the sleep mode, the designer may set small hcsp and tgp for a couple of cycles followed by large hcsp and tgp for the floating point block. Data path in normal operating mode has high hcsp and tgp as most of the gates in the block may toggle in the cycle. The Instance-Switching-Charge histogram may be used to estimate the percentage p of Hot-Cells. If there is a narrow concentrated bar of high power instances, it is better that the Hot-Cells include that bar.

As an optional input, to get more accurate results and to better estimate the switching time of a gate, the static timing analyzer (“STA”) report may be used. The STA report specifies the timing window that a non-special gate may switch. If the report is not available for a gate, it is assumed that it may switch during the complete cycle of its domain-clock. The exact time that a gate does switch is estimated statistically according to the algorithm presented in FIGS. 2a and 2b.

In a presently preferred embodiment of the present invention, referring to FIG. 2a, in a first step 20, a method for generating and sorting the instance switching charge information, such as the Instance-Switching-Charge histogram, is used and information with respect to each cell and its instance information is now available. Now, as indicated at 21, for each instance, a determination is made with respect to its switching probability as a function of its power, where a higher power instance is associated with higher probability of switching. Step 21 can be carried out in several sub-steps. As illustrated, in a sub-step 22, higher power instances are designated as Hot-Cells, where Hot-Cells are determined by a variety of methods, such as Hot-Cells of p % as described above, or any Hot-Cells having instance switching charge value over a certain user-defined value, or other methods. Once the Hot-Cells are determined, the switching probability of each Hot-Cell can be determined as a function of the user-defined hcsp. The pseudo-code below provides a sample application of this algorithm using hcsp:

For each Hot-Cell, c,

if (rand() < hcsp) then

assign 0 to 1 switching for c;

else

let t = rand ();
if (t < ⅓) then

assign 1 to 0 switching for c;

else if (t < 2/3) then

c will stay at 0;

else

c will stay at 1;

end if;

In the next sub-step 26, the non-Hot-Cell switching probability is determined for each non-Hot-Cell. The pseudo-code below provides a sample application of this algorithm:

For each of the non-Hot-Cell, c,

let t0 = rand(), t1 = rand ();
if (t0 < tgp && t1 < 0.5) then

assign 1 to 0 switching for C;

else if (t0 < tgp && t1 >= 0.5) then

assign 0 to 1 switching for c;

else if (t0 >= tgp && t1 < 0.5) then

c will stay at 0;

else

c will stay at 1;

end if;

Now that the probability of switching for each instance has been determined, the timing information for each instance is now determined (as indicated at 27). For each special instance 28, its switching time is as specified in the design. For each non-special instance 30, the following algorithm is applied:

If (its switching timing window is available from STA report) then

let tmin and tmax be the minimum and maximum of that window;

assign the instance to switch at a time between tmin and tmax based on rand () and slew;

else

assign the instance to switch at a time in the cycle of its domain-clock based on rand () and slew;

endif;

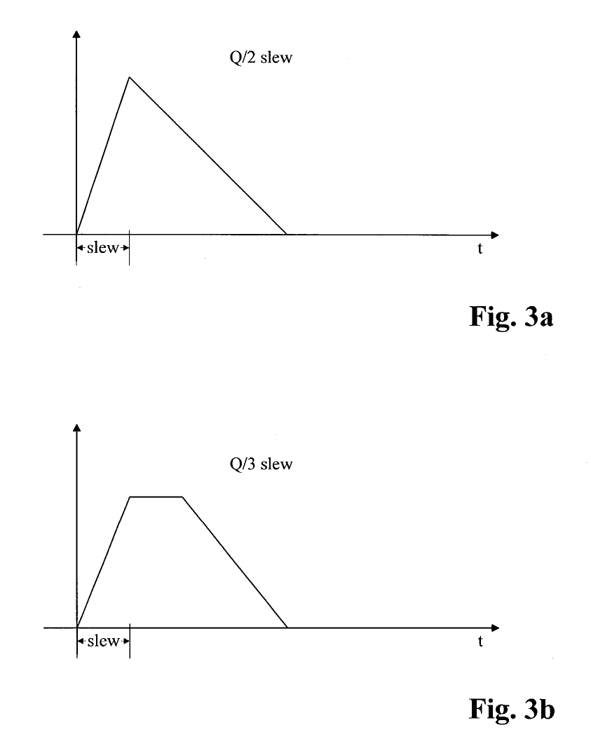

Referring to FIG. 2b, in the next step 31, there are two ways for identifying the equivalent load information. In a first method 32, for each instance, from its switching charge and the switching condition assigned above, determine the approximate load current waveform between each Vdd-Gnd pin pair of it. As illustrated in FIGS. 3a and 3b, the waveform may be a triangle or a trapezoid with total charge Q. They are functions of slew and their total integration should be equal to the switching charge of the instance. Note the trapezoidal waveform show the current is limited by a maximum driving current constraint, which is set by the gate's output transistor.

In an alternative method 34, for each instance, from its switching charge and the switching condition assigned above, it is determined the approximate time-varying resistors connected between each Vdd-Gnd pin pair of it. Each resistor takes slew (in pico-second) to decrease from a huge OFF resistance to an ON resistance and then stay at that value. The current flowing at the resistor will be an exponentially decaying function after the resistor keeps that ON value. The total integration of the current flowing at each pair is equal to the switching charge of the instance.

In the next step 36, an optional step, the intrinsic decoupling capacitors of the instances are determined. Their values may be determined from circuit simulations if their transistor netlists are available. Or, they may be approximated by the load capacitance of an output staying at 1. It is because that if an output is 1, there is an ON-PMOS connected path between that output and a Vdd pin. As the output capacitance is connected between that output node and a gnd pin this capacitance is an intrinsic decap between power and ground.

In the next step, 38, the RLC parasitic networks is extracted out of the power and ground networks, where C are the coupling capacitors between power and ground. After the extraction of the RLC parasitic networks, in the next step 40, transient simulation is conducted, which may include the intrinsic decaps information determined from step 36. The transient circuit simulation is performed on the circuit with the load current waveforms determined from step 32 or with the time-varying resistors determined from step 34. In general, the time-varying resistor model achieves better accuracy but demands more computations in transient simulation. The waveform at each node is recorded to determine Red-Cells and Target-Cells as described below.

As indicated at 41, the process described above may be repeated a number of times, each time with a different random number generator seed. At the end of this process 42, the generated information is reported in the desired format(s).

II. Statistical Vectorless Dynamic-IR Analysis Based on Peak-to-Average-Power Scenario

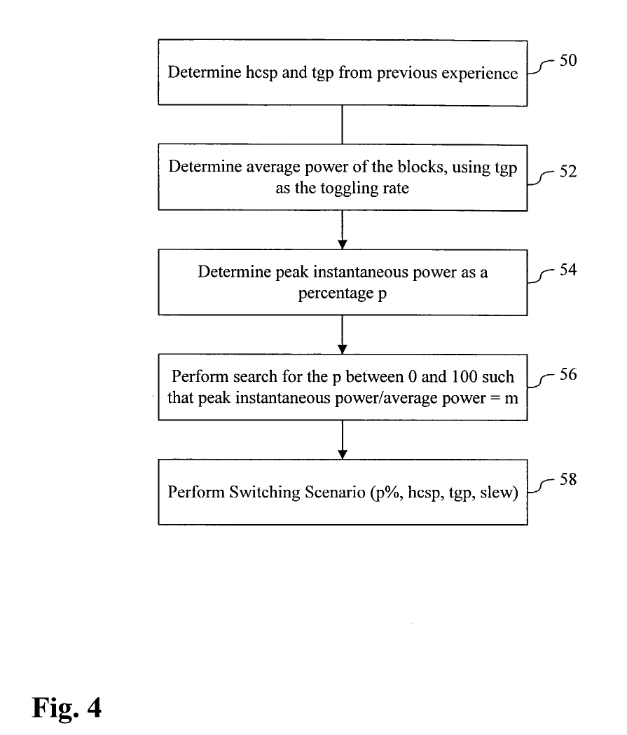

Here, referring to FIG. 4, a different method for constructing switching scenario is presented, specifically Peak-to-Average-Power Scenario of (m, slew) as described above. In a first step 50, the high-power instance 0->1 switching probability hcsp and the toggling rate of low-power instances tgp for the blocks based on previous design experience is determined. Normally, the same classes of designs have very similar hcsp and tgp. In the next step 52, using the tgp as the toggling rate, the average power of the block may be determined as AvgP. Given a percentage p, it may be determined the peak instantaneous power in Switching Scenario (p %, hcsp, tgp, slew) algorithm as described above in section I. The instantaneous power is the total current to the block multiplied by Vdd. Note that transient simulation is not needed if the load current waveform model is employed. Let the peak instantaneous power be PeakP. Next 56, binary search is performed to search for the p between 0 and 100 such that PeakP/AvgP=m. Finally, the Switching Scenario (p %, hcsp, tgp, slew) algorithm of section I is performed.

III. Determination of Target-Cells for Decap Protection

One important usage from the statistical vectorless dynamic-IR analysis is that the transient waveforms at the nodes of the power-ground networks may be used to identify Target-Cells out of Red-Cells. Target-Cells are those vulnerable cells needing decap-protection. In general, the number of Target-Cells should be much less than that of Red-Cells because the insertion of decap at one Target-Cell will help stabilize the power-ground around that area and remedy the integrity problems for many Red-Cells in that area. Apparently, high-power Red-Cells are good candidates for Target-Cells. Also, decaps should be inserted as close to the hot noise sources as possible. The stabilization capability from decaps decays very quickly as the distance increases. Two methods are presented here.

A. Determination of Target-Cells of (p %, Vr) Based on Worst Vdd-Gnd Voltage

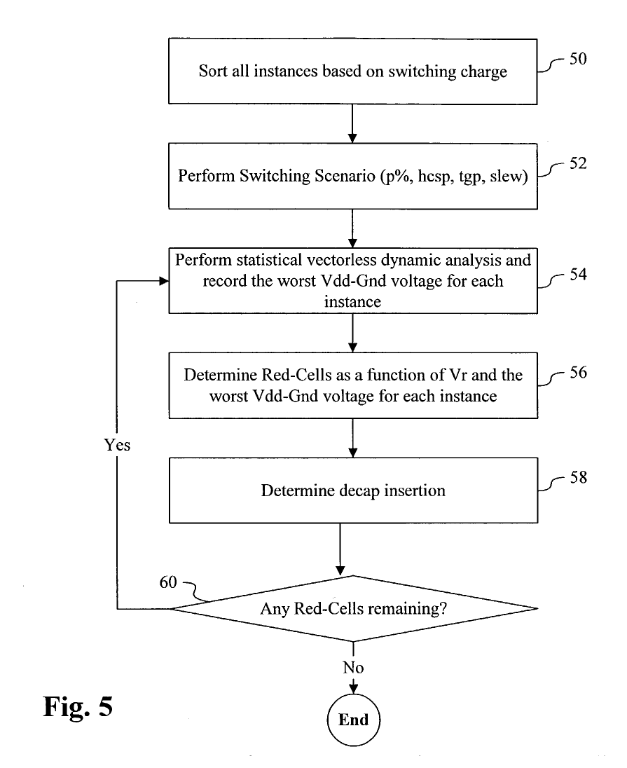

Here, referring to FIG. 5, in a first step 50, all instances are sorted in descending order based on their 0->1 switching charge in descending order. The highest power instances are at the top of the list. Next 52, the switching scenario is constructed using Switching Scenario (p %, hcsp, tgp, slew). In the next step 54, statistical vectorless dynamic-IR analysis, as described above (either method), is performed. During the analysis, the worst Vdd-Gnd voltage for each instance is recorded. Next 56, using Vr as the constraint, the Red-Cells are determined by comparing whether the worst Vdd-Gnd voltage of an instance is less than Vr. Decap insertion is determined in the next step 58. The follow is a sample algorithm using the worst Vdd-Gnd voltage:

For each of the first N high-power instances:

let Vw be its worst Vdd-Gnd voltage;

let q be its 0->1 switching charge;

let dc=alpha * (Vr−Vw)* q;

if (dc>beta) insert decap of dc near this instance;

The numbers N, alpha, and beta in the algorithm need to be tuned to achieve the best performance and run-time trade-off. The purpose of beta is to screen out insertions of tiny decaps and N is used to avoid too many insertions in each iteration. If there are any Red-Cells remaining 60, meaning that there are more cells requiring decap insertion, the process is repeated. Otherwise, the process is complete.

B. Determination of Target-Cells of (p %, Vr) Based on Voltage Derivatives

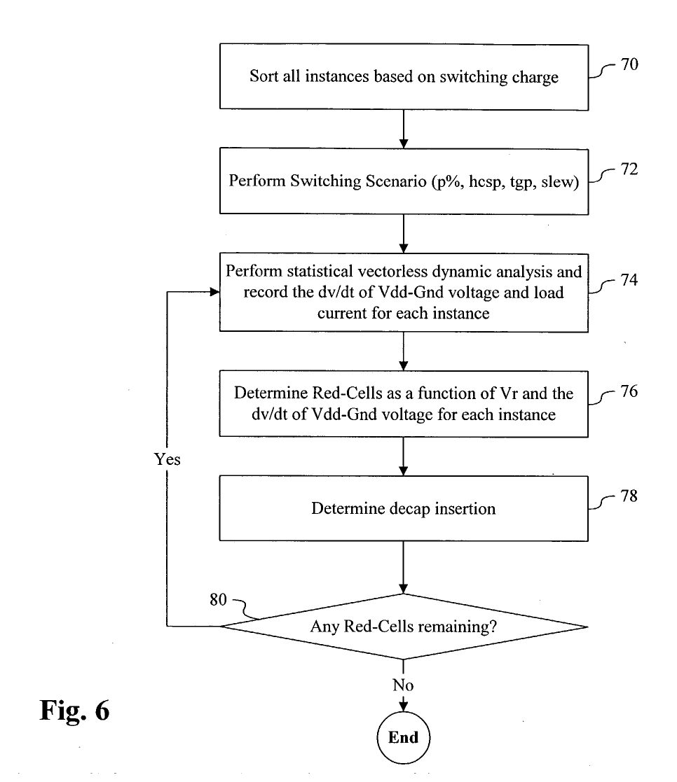

Here, in a second method for the determination of Target-Cells for decap insertion, referring to FIG. 6, in a first step 70, all instances are sorted in descending order based on their 0->1 switching charge in descending order. The highest power instances are at the top of the list. Next 72, the switching scenario is constructed using Switching Scenario (p %, hcsp, tgp, slew). In the next step 74, statistical vectorless dynamic-IR analysis, as described above (either method), is performed. During the analysis, the dv/dt of the Vdd-Gnd voltage for each instance when the peak noise occurs is recorded, and, also, the load current at that instance is recorded. Next 76, using Vr as the constraint, the Red-Cells are determined by comparing whether the dv/dt of the Vdd-Gnd voltage of an instance is less than Vr. Decap insertion is determined in the next step 78. The follow is a sample algorithm using the dv/dt of the Vdd-Gnd voltage:

For each of the first N high-power instances:

let dV be its dv/dt of Vdd-Gnd voltage recorded;

let lc be its load current recorded;

let dc=alpha * (Vr−Vw)* lc * (dV+gamma);

if (dc>beta) insert decap of dc near this instance;

Similarly, the numbers N, alpha, beta, and gamma in the algorithm need to be tuned to achieve the best performance and run-time trade-off. If there are any Red-Cells remaining 80, meaning that there are more cells requiring decap insertion, the process is repeated. Otherwise, the process is complete.

While the present invention has been described with reference to certain preferred embodiments, it is to be understood that the present invention is not to be limited to such specific embodiments. Rather, it is the inventor's contention that the invention be understood and construed in its broadest meaning as reflected by the following claims. Thus, these claims are to be understood as incorporating and not only the preferred embodiment described herein but all those other and further alterations and modifications as would be apparent to those of ordinary skilled in the art.

We claim:

1. A method for determining instance switching in simulating integrated circuit design, comprising the steps of:
generating instances and respective instance switching charge information; and
determining instance switching as a function of said instance switching charge information.

2. A method as recited in claim 1 wherein said determining step further comprising the sub-steps of:
selecting certain instances as a function of said instance switching charge information;
determining the switching probability of said selected instances; and
determining the switching probability of non-selected instances.

3. A method as recited in claim 2 wherein said determining the switching probability of said selected instances step is determined as a function of a first user-provided probability value.

4. A method as recited in claim 2 wherein said determining the switching probability of non-selected instances step is determined as a function of a second user-provided probability value.

5. A method as recited in claim 3 wherein said determining the switching probability of non-selected instances step is determined as a function of a second user-provided probability value.

6. A method as recited in claim 2 wherein said determining the switching probability of said selected instances step is determined as a function of one or more random numbers.

7. A method as recited in claim 2 wherein said determining the switching probability of non-selected instances step is determined as a function of one or more random numbers.

8. A method as recited in claim 3 wherein said determining the switching probability of non-selected instances step is determined as a function of one or more random numbers.

9. A method as recited in claim 3 wherein said determining the switching probability of said selected instances step is determined as a function of one or more random numbers.

10. A method as recited in claim 9 wherein said determining the switching probability of non-selected instances step is determined as a function of one or more random numbers.

11. A method as recited in claim 4 wherein said determining the switching probability of said selected instances step is determined as a function of one or more random numbers.

12. A method as recited in claim 11 wherein said determining the switching probability of non-selected instances step is determined as a function of one or more random numbers.

13. A method as recited in claim 5 wherein said determining the switching probability of said selected instances step is determined as a function of one or more random numbers.

14. A method as recited in claim 13 wherein said determining the switching probability of non-selected instances step is determined as a function of one or more random numbers.

15. A method as recited in claim 1 wherein said determining instance switching step uses one or more random numbers.

16. A method for simulating integrated circuit design, comprising the steps of:
generating instances and respective instance switching charge information;
determining instance switching as a function of said instance switching charge information;
determining timing information for selected ones of said instances;
calculating load information;
extracting RLC parasitic networks; and
conducting transient simulation.

17. A method as recited in claim 16 further including an additional step, after said calculating step and before said extracting step, of determining intrinsic decaps of said selected instances.

18. A method as recited in claim 16 further including an additional step, after said conducting step, of reporting transient simulation results.

19. A method as recited in claim 16 wherein said calculating load information step is performed by determining the load current waveform for each instance.

20. A method as recited in claim 16 wherein said calculating load information step is performed by determining time-varying resistor in series with loading capacitor connecting between each Vdd-Gnd pin pair for each instance.

21. A method as recited in claim 17 further including an additional step, after said conducting step, of reporting transient simulation results.

22. A method as recited in claim 17 wherein said calculating load information step is performed by determining the load current waveform for each instance.

23. A method as recited in claim 17 wherein said calculating load information step is performed by determining time-varying resistor in series with loading capacitor connecting between each Vdd-Gnd pin pair for each instance.

24. A method as recited in claim 18 wherein said calculating load information step is performed by determining the load current waveform for each instance.

25. A method as recited in claim 18 wherein said calculating load information step is performed by determining time-varying resistor in series with loading capacitor connecting between each Vdd-Gnd pin pair for each instance.

26. A method for selecting and determining switching instances and switching probabilities in simulating integrated circuit design, said design comprising of a plurality of blocks, comprising the steps of:
determining switching probability based on empirical information;
determining average power of said blocks as a function of toggling rate;
determining peak instantaneous power as a function of a user-provided percentage;
searching for instances having said peak instantaneous power dividing said averaging
power equaling to a given multiplier;
determining instance switching as a function of instance charge information; and
determining timing information for selected ones of said instances.

27. A method for determining decoupling capacitor insertion in an integrated circuit design, comprising the steps of:
sorting generated instances based on respective instance switching charge of said instances;
determining switching scenario for said instances;
performing transient simulation based on said switching scenario to generate worst Vdd-Gnd voltage for said instances;
identifying cells needing decap insertion as a function of a threshold voltage, Vr, and said respective worst Vdd-Gnd voltage of said instances; and
determining decap insertion for said cells needing decap insertion.

28. A method for determining decoupling capacitor insertion in an integrated circuit design, comprising the steps of:
sorting generated instances based on the respective instance switching charge of said instances;
performing switching scenario for said instances;
performing transient simulation based on said switching scenario to generate dv/dt of Vdd-Gnd voltage for said instances;
identify cells needing decap insertion as a function of a threshold voltage, Vr, and said respective dv/dt of Vdd-Gnd voltage of said instances; and
determining decap insertion for said cells needing decap insertion.
